(19) United States
(12) Patent Application Publication
(10) Pub. No.: US 2008/0314604 A1
(43) Pub. Date: Dec. 25, 2008

(54) Plow

(76) Inventor: Keith Fluth, Dalbo, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/820,871

(22) Filed: Jun. 21, 2007

(51) Int. Cl. A01B 13/08; A01B 13/10; A01B 15/08

(52) U.S. Cl. 172/63; 172/196

(57) ABSTRACT

An improved moldboard plow having a soil engaging shank mounted behind the moldboard plow bottoms. The soil engaging shank is extendable to a depth of six to eight or more inches below the point reached by the moldboard plow bottoms. Both the moldboard and the shank are fitted with trip mechanisms to raise them up when either or both encounter a hard buried object. Preferably the shank includes a hydraulic cylinder for raising and lowering the shank as needed.

### FIELD OF THE INVENTION

The present invention relates to an improved plow. More particularly, the invention relates to an improvement to a moldboard plow enabling it to reach substantially deeper into the soil.

### BACKGROUND OF THE INVENTION

Moldboard plows have been virtually the same, except for size, for at least the last fifty years. A moldboard plow includes a leading cutter to slice surface plants and a curved plow tip that engages the soil. The moldboard plow tips over or turns over the top six to eight inches of soil, and has been found to be effective in many soils, increasing the yield of corn, for example by ten to fifteen bushels per acre in some cases and in other soil up to forty bushels per acre.

The problem with moldboard plows is that they sometimes create a hard layer at the depth of the plow tip, and this layer prevents the roots from going deeper. In dry climates or during a less than average rainfall growing season, the roots do not go deep enough to get the proper moisture. Crop yield suffers.

An alternative to the moldboard plow is a chisel plow or cultivator shank which cuts deeper into the soil. However, these plows do not turn the soil. With increased fuel costs, it is no longer economical to first plow a field with a moldboard plow and follow up with a second plowing using a chisel plow.

Another current trend is to plant corn in more fields and to skip planting alternative crops in fields because the demand for corn is increasing dramatically as an alternative energy source.

It would be of advantage in the art if a moldboard plow could be improved to eliminate the formation of a hard subsurface layer.

It would be another advance in the art if the advantages of a moldboard plow could be retained while reaching deeper into the soil.

Other advantages will appear hereinafter.

### SUMMARY OF THE INVENTION

It has now been discovered that the above and other advantages of the present invention may be obtained in the following manner. Specifically, the present invention provides an improved moldboard plow by adding a second plow point behind the moldboard bottoms. The second plow point extends deeper into the soil, at least doubling the depth reached by conventional moldboard plows.

In its simplest form, the present invention comprises a shank, similar to a chisel plow or cultivator shank, directly behind each moldboard bottom. The shank extends from six inches to eight inches or more deeper than the furrow. As the shank follows behind the moldboard plow bottoms, it breaks up the flow pan and functions like a subsoiler.

The shanks, one for each moldboard bottom, is connected directly to the moldboard so that when the moldboard strikes a rock or other buried hard object, it would trip up as does the moldboard. The shank is also provided with its own trip to protect it in case it encounters a hard object at its greater depth.

Typical moldboard plows are raised when moving to and from a field and when turning around. The shank portion is adapted to rise a greater distance to avoid contact with the ground. This can be done either by modifying the moldboard plow component to raise to the higher required elevation or by a separate lift for the shank component.

In a preferred embodiment, a hydraulic cylinder is mounted behind each moldboard bottom. The cylinder would be adapted to raise or slide the shank up and down independently of the moldboard bottom. Preferably, the shanks would be inside a channel or conduit that would hold the shank and allow it to be raised or lowered to any depth when plowing. The cylinder and shank would trip by the same mechanism.

### BRIEF DESCRIPTION OF THE DRAWINGS

For a more complete understanding of the invention, reference is hereby made to the drawings, in which:

FIG. 1 is a schematic side elevational view of the present invention.

### DETAILED DESCRIPTION OF THE PREFERRED EMBODIMENT

The present invention provides for substantial improvements in plowing by combining a conventional moldboard plow with a plurality of bottoms, each of which includes a shank extending below the bottom to further turn the soil during plowing.

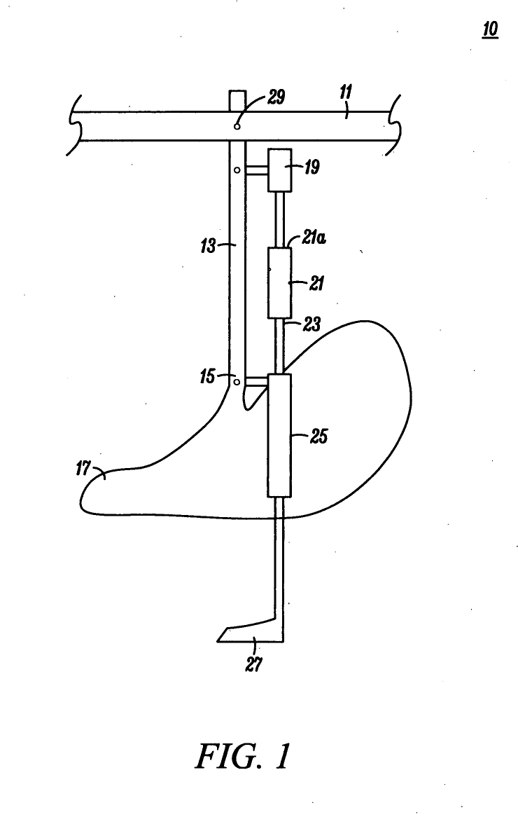

As seen in FIG. 1, a conventional moldboard plow, 10 generally, has a frame 11 that supports a plurality of moldboard bottom supports 13 extending down to its lower portion 15 which mounts bottom 17. This moldboard plow bottom 17 is shown as one element, but it is to be understood that conventional moldboard plows have a large number of bottoms 17. In essentially all commercially available moldboard plows, the design is that the soil strip is turned over in only one direction. Multiple plows have been mounted on a single frame, which results in staggering the rows of plows. For purposes of illustrating this invention, only one plow bottom 17 is shown.

Also mounted on bottom support 13 is a cylinder support 19 which in turn mounts a hydraulic cylinder 21. Cylinder 21 raises and lowers a bracket 23 through shaft 25 that in turn mounts the soil engaging shank element 27. Shank 27 engages the soil at a point below that of bottom 17. Shank 27 can extend up to twelve inches and preferably extends into the soil by between six and eight inches below that reached by said moldboard plow bottoms 17. Cylinder 21 can adjust this depth over the whole range as set forth here.

Most moldboard plows are fitted with a release component that allows the bottoms 17 to be raised when the bottom 17 strikes a rock or other hard object as it moves through the soil. It is contemplated that the shank 17 will also rise when this component raises the bottoms 17. Frame 11 includes a pivot point 29 that moves in the counterclockwise direction as seen in FIG. 1, moving the bottom 17 and shank 27 back up from the hard object, not shown. In addition, cylinder 21 is fitted with a pressure release valve 21a inside the cylinder that raises the shank 27 when needed.

A particular advantage of the present invention is that the forces of bottom 17 are to one side since the bottoms all turn the soil in one direction essentially perpendicular to the direction of travel of the plow. Shank 27 engages the soil at a greater depth and serves as a counter force to the side forces of bottom 17.

Shank 27 also increases the yield of the corn planted by this plow because it plows deeper than a moldboard plow can reach, thus reaching the heavy under soil and turning it over. It is estimated that a yield of 140 to 225 bushels per acre will be increased by the present invention by from ten to fifteen bushels per acre up to forty bushels per acre.

While particular embodiments of the present invention have been illustrated and described, it is not intended to limit the invent

1. A moldboard plow device for plowing soil, comprising:
a moldboard plow having a plurality of plow bottoms reaching to a predetermined depth in the soil;
a soil engaging shank element mounted behind substantially all of said moldboard plow bottoms on said moldboard plow for engaging said soil at a greater depth, said soil engaging shank element extending to a substantial depth below the point reached by said moldboard plow bottoms;
said moldboard plow bottoms and said shank element including a trip mechanisms to raise them up when either or both encounter a hard buried object; and
a lifter for raising and lowering said shank element as needed.

2. The device of claim 1, wherein a shank element is mounted behind every one of the plurality of plow bottoms.

3. The device of claim 1, wherein soil engaging shank element extends into said soil by up to twelve inches below that reached by said moldboard plow bottoms.

4. The device of claim 3, wherein soil engaging shank element extends into said soil by between six and eight inches below that reached by said moldboard plow bottoms.

5. The device of claim 1, wherein said lifter is a hydraulic cylinder capable of being attached to a source of hydraulic fluid for controlling movement of said shank element.

6. The device of claim 1, wherein said trip mechanism for said moldboard plow bottoms raises both said moldboard plow bottoms and said shank element.

7. The device of claim 6, wherein said shank element further includes a separate trip mechanism for raising only said shank element when said shank element encounters a hard buried object.

8. A moldboard plow device for plowing soil, comprising:
moldboard plow means for positioning a plurality of plow bottoms reaching to a predetermined depth in the soil;
soil engaging shank means mounted behind substantially all the moldboard plow bottoms on said moldboard plow means for engaging said soil with shanks at a greater depth, said soil engaging shank means extending to a substantial depth below the point reached by said moldboard plow bottoms;
said moldboard plow means and said shank means including a trip mechanisms to raise them up when either or both encounter a hard buried object; and
lifter means for raising and lowering said shank means as needed.

9. The device of claim 8, wherein said shank means mounts a shank behind every one of the plurality of plow bottoms.

10. The device of claim 8, wherein soil engaging shank means extends into said soil by up to twelve inches below that reached by said moldboard plow means.

11. The device of claim 10, wherein soil engaging shank means extends into said soil by between six and eight inches below that reached by said moldboard plow means.

12. The device of claim 8, wherein said lifter means includes a hydraulic cylinder capable of being attached to a source of hydraulic fluid for controlling movement of said shank means.

13. The device of claim 8, wherein said trip mechanism for said moldboard plow means raises both said moldboard plow means and said shank means.

14. The device of claim 13, wherein said shank means further includes a separate trip mechanism for raising only said shank means when said shank means encounters a hard buried object.

15. A method of plowing soil, comprising, the steps of:
providing a moldboard plow having a plurality of plow bottoms reaching to a predetermined depth in the soil;
mounting a soil engaging shank element behind the moldboard plow bottoms on said moldboard plow for engaging said soil at a greater depth, said soil engaging shank element extending to a substantial depth below the point reached by said moldboard plow bottoms;
said moldboard plow bottoms and said shank element including a trip mechanisms to raise them up when either or both encounter a hard buried object;
a lifter for raising and lowering said shank element as needed; and
plowing with said moldboard plow with said shank element engaged.

16. The method of claim 15, wherein soil engaging shank element extends into said soil by up to twelve inches below that reached by said moldboard plow bottoms.

17. The device of claim 15, wherein said lifter is a hydraulic cylinder capable of being attached to a source of hydraulic fluid on the vehicle used to pull said moldboard plow with said shank element engaged, for controlling movement of said shank element.

18. The device of claim 15, wherein said trip mechanism for said moldboard plow bottoms raises both said moldboard plow bottoms and said shank element.

19. The method of claim 18, wherein said shank element further includes a separate trip mechanism for raising only said shank element when said shank element encounters a hard buried object.
